(19) United States
(12) Patent Application Publication
(10) Pub. No.: US 2017/0245179 A1
(43) Pub. Date: Aug. 24, 2017

(54) Method and Apparatus for Dynamic Backhaul Resource Allocation in a Radio Access Network

(71) Applicants: Aaron CALLARD, Ottawa (CA); Philippe LEROUX, Ottawa (CA)

(72) Inventors: Aaron CALLARD, Ottawa (CA); Philippe LEROUX, Ottawa (CA)

(73) Assignee: Huawei Technologies Co., Ltd., Shenzhen (CN)

(21) Appl. No.: 15/050,915

(22) Filed: Feb. 23, 2016

(51) Int. Cl. H04W 28/18; H04W 72/08; H04W 24/04; H04W 72/12

(52) U.S. Cl. CPC H04W 28/18; H04W 72/1231; H04W 72/121; H04W 72/085; H04W 24/04

(57) ABSTRACT

Methods and apparatus for resource allocation in the backhaul network of a radio access network are provided. Devices such as schedulers communicate utility functions to a traffic engineering controller. Each utility function expresses amount of utility associated with at least one prospective backhaul resource allocation, from the perspective of the device or clients or UEs served thereby. The traffic engineering controller incorporates the utility functions into an objective to be maximized, subject to constraints such as backhaul link capacity constraints. A backhaul resource allocation is determined by solving a corresponding optimization problem. The traffic engineering controller then instructs various entities in the backhaul network to implement the resource allocation.

### FIELD OF THE INVENTION

The present invention pertains to the field of communication networks and in particular to a method and apparatus for dynamic backhaul resource allocation in a radio access network.

### BACKGROUND

Access nodes, such as evolved nodeBs (eNBs) or other Access Points, of a Radio Access Network (RAN) are capable of communicating with each other as well as with other nodes such as gateways via a backhaul network. For example, the Long Term Evolution (LTE) standard allows communication between eNBs via an X2 interface. An original use for the X2 interface was to enable mobility management and transfer of user data from one eNB to another in the event of a handover.

Cooperation and coordination between access nodes can enhance RAN performance. For example, access nodes within range of the same User Equipment (UE) can jointly receive uplink data from the UE. As another example, multiple access nodes can implement a Coordinated Multipoint (CoMP) scheme, in which multiple access nodes avoid interfering with each other and/or cooperate to transmit data to or receive data from a UE. As yet another example, access nodes can participate in coordinated scheduling by sharing scheduling information.

However, such cooperation and coordination requires communication between access nodes using the backhaul network. Because backhaul resources are limited, it is desirable to deploy those resources in an effective manner.

Therefore there is a need for a method and apparatus for dynamic backhaul resource allocation in a radio access network that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present invention is to provide a method and apparatus for dynamic backhaul resource allocation in a radio access network. In accordance with embodiments of the present invention, there is provided a method of resource allocation in a backhaul network forming part of a radio access network, for execution by a network node, comprising: identifying a requirement for backhaul resources to be allocated for supporting flows of data between two or more network nodes in the backhaul; and transmitting an indication of a utility function, expressing a utility metric associated with a prospective backhaul resource allocation, to an entity configured for influencing backhaul resource utilization, such as a traffic engineering (TE) controller.

In accordance with embodiments of the present invention, there is provided a method of resource allocation in a backhaul network forming part of a radio access network, for execution by a traffic engineering (TE) controller device, comprising: receiving one or more indications of utility functions from network nodes and/or network controller devices of the RAN; generating an objective function based at least partially on the indicated utility functions; obtaining a set of constraints on backhaul resource allocations; generating a resultant backhaul resource allocation which satisfies the set of constraints; and directing an allocation of resources according to the resultant backhaul resource allocation.

In accordance with embodiments of the present invention, there is provided an apparatus for resource allocation in a backhaul network forming part of a radio access network, comprising a microprocessor operatively coupled to memory and a network interface and configured to: identify, using the microprocessor and based at least partially on information received via the network interface, a requirement for backhaul resources to be allocated for supporting flows of data between network nodes; and transmit, using the network interface, an indication of a utility function, expressing a utility metric associated with a prospective backhaul resource allocation, to an entity configured for influencing backhaul resource utilization, such as a traffic engineering (TE) controller.

In accordance with embodiments of the present invention, there is provided an apparatus for resource allocation in a backhaul network forming part of a radio access network, comprising a microprocessor operatively coupled to memory and a network interface and configured to: receive, using the network interface, one or more indications of utility functions from network nodes and/or network controller devices of the RAN; generate, using the microprocessor, an objective function based at least partially on the indicated utility functions; obtain, using one or both of the network interface and the microprocessor, a set of constraints on backhaul resource allocations; generate, using the microprocessor, a resultant backhaul resource allocation which satisfies the set of constraints; and direct, using the network interface, an allocation of resources according to the resultant backhaul resource allocation.

### BRIEF DESCRIPTION OF THE FIGURES

Further features and advantages of the present invention will become apparent from the following detailed description, taken in combination with the appended drawings, in which:

FIG. 1 illustrates a method for backhaul resource allocation in accordance with an embodiment of the present invention.

FIG. 2 illustrates a method for backhaul resource allocation in accordance with another embodiment of the present invention.

FIG. 3 illustrates a portion of a RAN to be operated in accordance with an embodiment of the present invention.

FIG. 4 illustrates an example graph of a utility function in accordance with an embodiment of the present invention.

FIG. 5 illustrates an example graph of a utility function in accordance with another embodiment of the present invention.

FIG. 6 illustrates a device configured to perform backhaul resource allocation in accordance with an embodiment of the present invention.

FIG. 7 illustrates a TE controller configured to perform backhaul resource allocation in accordance with another embodiment of the present invention.

It will be noted that throughout the appended drawings, like features are identified by like reference numerals.

### DETAILED DESCRIPTION

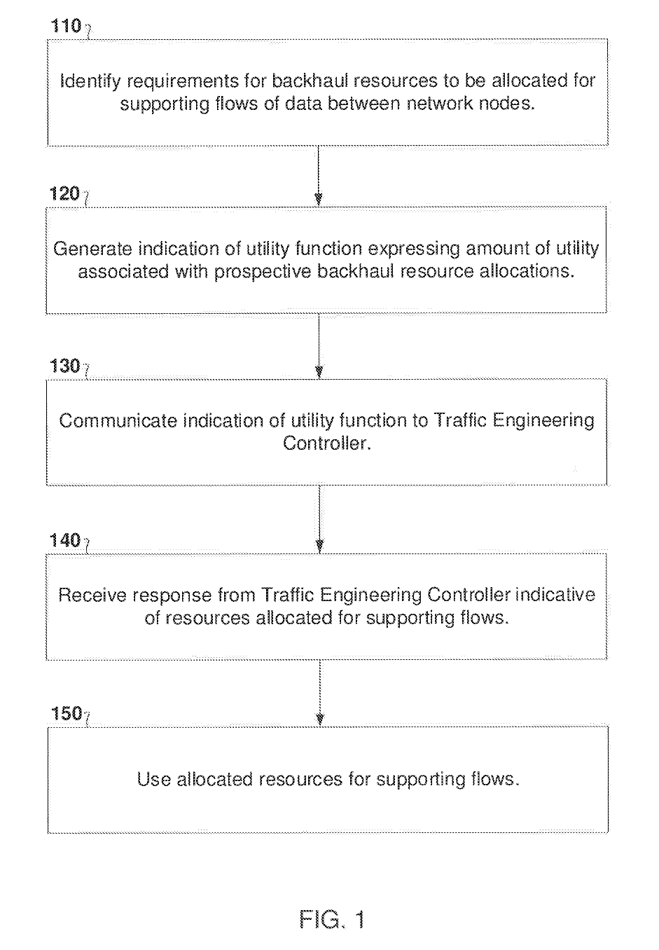

Embodiments of the present invention are directed toward a method and apparatus for resource allocation in a backhaul network forming part of a radio access network. Accordingly, with reference to FIG. 1, the following operations are performed by an entity in the network. The entity may be a network node or network controller device, or a function instantiated at a network node or network controller device. The network controller device may be a scheduler or other supervisory node assisting with control of the radio access network, and may thus be considered to be a network node. The operations include identifying 110 requirements for backhaul resources to be allocated for supporting flows of data between two or more network nodes. For example, a first flow may include uplink data flowing from an access node to a gateway, or downlink data flowing from the gateway to the access node. A second flow may include data flowing between two access nodes, for example in support of a cooperative transmission or reception strategy, a handover operation, or the like. A backhaul resource allocation may include an amount of bandwidth or data rate reserved or allocated for use by a given flow or set of flows between backhaul nodes. The operations include generating 120 an indication of a utility function which expresses an amount of utility, also referred to as a utility metric, associated with at least one prospective backhaul resource allocation. Alternatively, the utility function may be generated by another entity. The utility function may express multiple amounts of utility associated with a corresponding plurality of prospective backhaul resource allocations. The operations further include communicating 130 the indication of the utility function to a traffic engineering (TE) controller or other external entity configured for influencing backhaul resource utilization. The communication may for example include a control message transmitted via the backhaul network. In some embodiments, the operations further include receiving 140 a response from the TE controller indicative of resources which have been allocated for supporting the given flow or flows of data between network nodes. The indicated allocated resources can then be used 150, for example under direction of the network controller device, for supporting the given flow or flows.

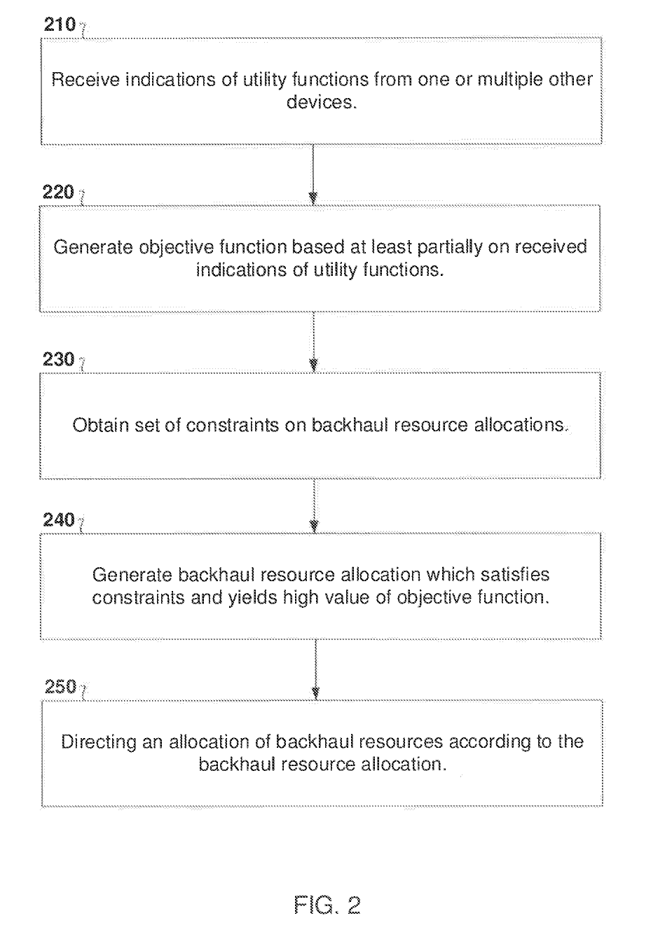

Embodiments of the present invention are directed toward a method and apparatus for backhaul resource allocation in a radio access network. Accordingly, with reference to FIG. 2, the following are operations performed by an entity such as a TE controller or associated TE controller function, or by another entity configured for influencing backhaul resource utilization. The entity is configured to directly or indirectly influence backhaul resource allocations, such as amounts of bandwidth or data rates set aside for specific data flows through the backhaul network. The operations include receiving 210 one or more indications of utility functions from network nodes and/or network controller devices of the RAN. The operations further include generating 220 an objective function based at least partially on the indicated utility functions. The objective function provides a value as a function of the backhaul resource allocation. The objective function may be an increasing function of each of the indicated utility functions, so that the overall objective is to maximize utility. The operations further include obtaining 230 a set of constraints on backhaul resource allocations. The constraints can reflect, for example, upper limits on the data rates which can be supported by specified communication links in the backhaul network. The operations further include generating 240 a resultant backhaul resource allocation which satisfies the set of constraints and which yields an adequately high value of the objective function. The resource allocation may correspond to support of a given amount of data rate which is set aside on specified backhaul links, virtual or physical for use by specified flows. For example, the resultant backhaul resource allocation can be obtained via a constrained optimization calculation and may have a substantially locally or globally maximal utility, or a utility which is at least equal to a predetermined threshold value. The operations further include directing 250 an allocation of resources according to the resultant backhaul resource allocation. The resource allocation may include provisioning of backhaul resources for use by specified flows and/or configuring the network according to the resource allocation. Directing the resource allocation may include directly configuring the network according to the resource allocation and/or communicating to network nodes and/or network controllers of the backhaul network, instructions to configure the network according to the resource allocation.

It will be readily understood that a utility function can equivalently be replaced with a cost function, with the corresponding goal being to minimize an objective function which is based on the cost functions. That is, rather than the objective being to maximize a utility representing benefits, the objective may be to minimize a cost representing drawbacks or a negative of system benefits. It is considered herein that the minimization of a cost function and the maximization of a utility function are substantially equivalent operations, and the present disclosure focuses on the maximization of utility for clarity.

In some embodiments, the utility function may be expressed as a collection of flows, with possibly different priorities and requirements. Combined together these flows may effectively express a single utility function.

For example, in some embodiments the language (formatting) used to express the utility function may have at least a limited amount of flexibility. For instance, in one embodiment a flow may only be associated with a maximum demand (e.g. a maximum rate dₘₐₓ after which the utility no longer increases) and a fixed weight w. This flow may be represented for example by the utility function U(d)=w*min(d,dₘₐₓ). Given a limited language for expression, a more complicated utility function may be expressed as a combination of flows, with the same sources and destinations but different demands and weights. The effective utility function in this case may be given by a sum of component utility functions: U(d)=Σᵢwᵢ min(dᵢ, d_{max,i}). Here, wᵢ and d_{max,i} are parametric values, and d is a vector with components dᵢ.

In some embodiments the utility function may be implicitly expressed, where parameters necessary for utility function generation are exchanged. These parameters may include, for example, the characterizations of backhaul traffic, in terms of mean traffic, peak traffic, traffic variance, or the like.

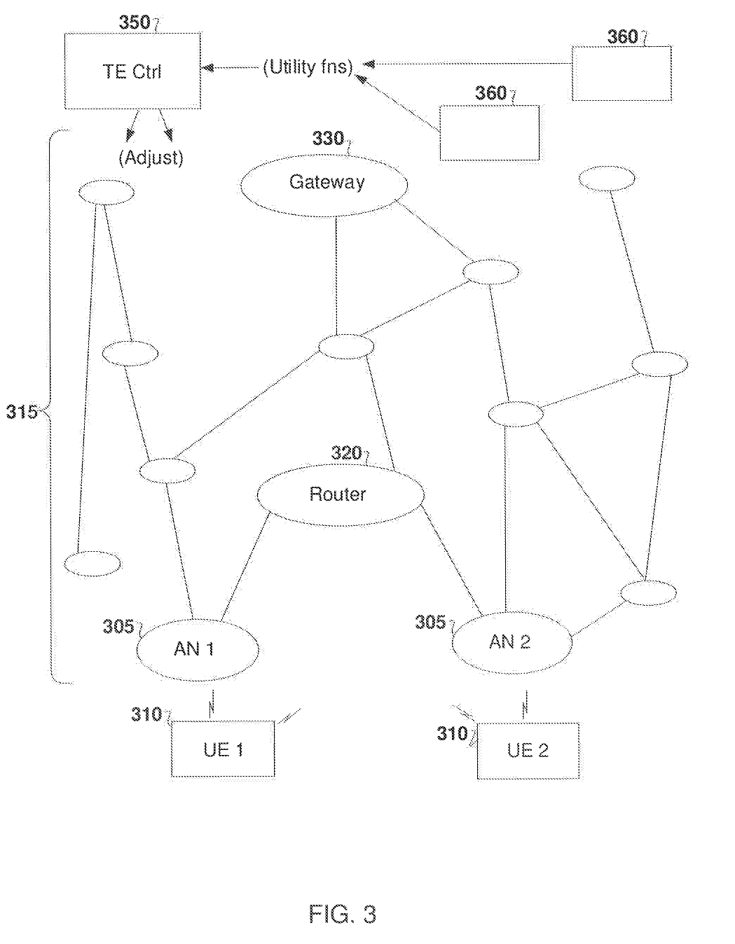

FIG. 3 illustrates a portion of a RAN to be operated in accordance with an embodiment of the present invention. The RAN includes a plurality of access nodes 305, such as eNBs, configured for wireless communication with UEs 310, for example to receive uplink data therefrom and to transmit downlink data thereto. As used herein, the term “UE” is used for clarity. However, the UE may refer to one of a variety of devices, such as mobile devices, stationary or mobile machine-type devices, or the like, which communicate with an access node via wireless communication. The access nodes are further communicatively coupled to a backhaul network 315 which may include wired, wireless and/or optical communication links. The backhaul network may include infrastructure devices such as router 320. At least some of the infrastructure devices may be configured to implement data processing functions which can operate on the uplink and/or downlink data. Access nodes can communicate with each other and/or with Gateway nodes 330, such as serving gateways (SGWs) or packet gateways (PGWs), or combinations thereof, via the backhaul network. In some embodiments, access nodes may use an interface such as the X2 interface to communicate with each other via a direct or indirect data link. Uplink data received by access nodes from UEs can traverse the backhaul network to a defined gateway node, and downlink data can likewise traverse the backhaul network from a gateway node to one or more access nodes for transmission to a defined UE. Supportive data, referred to herein as companion flow data, can also traverse the backhaul network from one node to another, such as from one access node to another.

One skilled in the art will appreciate that a mobile device is a device designed to connect to a mobile network. This connection typically makes use of a wireless connection to an access node. Although the mobile network is designed to support mobility, it is not necessary that the mobile device itself be mobile. Some mobile devices, such as metering devices (e.g. smart meters) may not be capable of mobility, but still make use of the mobile network.

FIG. 3 further illustrates a TE controller 350 which is configured to receive communications from nodes of the RAN and to adjust the allocation of backhaul resources based on the received communications. The communications can be interpreted as requests to allocate backhaul resources in support of communication activities to be performed by the requesting nodes. The communications include an indication of a utility function as described herein. The backhaul resources can include communication resources sufficient to sustain a specified data rate. For example, backhaul resources can include time slots and/or frequency band resources of a communication link which are used to communicate data. In some embodiments, backhaul resources are specified in a stochastic manner, such as in the case of shared resources over an Ethernet link. For example, backhaul resources may be expressed in terms of hard reservation limits, or through soft limits which serve both an average rate and a peak rate. Backhaul resources can also include processing resources, such as router processing resources, which serve enqueued data packets. Allocating backhaul resources may include setting aside or reserving those resources for a particular use, such as supporting a particular data flow, or forwarding various traffic in such a way that the resource allocations are satisfied. Traffic behaviour may be enforced to be within resource allocation limits through techniques such as traffic shaping, traffic labelling, active queue management, etc.

FIG. 3 further illustrates a plurality of devices 360 which are configured to transmit the requests to allocate backhaul resources to the TE controller. The devices can be schedulers, network nodes, network controllers, or corresponding control functions, for example. A scheduler may request backhaul resource allocations in association with its other scheduling activities, such as scheduling wireless data transmissions to and/or from UEs.

In various embodiments, some or all access nodes may be provided separately from a scheduler. Further, a scheduler may be associated with and perform scheduling activities for multiple access nodes. Alternatively, each access node may be associated with a scheduler.

In various embodiments the access nodes are virtualized access nodes, which may be provided using functions and/or treated as functions which provide functionality currently performed by standard access nodes. These access nodes are configured to convert over-the-air signals into (fully decoded) upper layer data, such as IP packets. This conversion may be done by a single node or through a series of functions, possibly implemented as a service function chain. In some embodiments, access node functions may be instantiated on equipment in a data center, for example supporting a centralized or cloud-based radio access network (C-RAN).

In some embodiments, a backhaul refers to communication between two nodes over a medium different from the primary access resources. It may refer to links between two access nodes over wired or wireless resources. In some embodiments, the backhaul is a superset of the fronthaul. In some embodiments, the backhaul is not formally distinguished from the fronthaul.

Embodiments of the present invention provide a method and apparatus for negotiating the allocation of backhaul resources for use in implementing what are referred to herein as “companion flows”. Companion flows carry data which is passed between network nodes, such as access nodes and/or schedulers and/or other network nodes at which support functions are instantiated. In particular, companion flows carry data which is usable to improve RAN performance, for example by expanding the rate region of a wireless access link supported by the RAN. The rate region is a conventional metric for networks describing the set of possible information transfer rates, as would be readily understood by one skilled in the art. Companion flows are typically not required for basic operation, but rather are usable for enhancing performance of the wireless communication system above a baseline level.

In some embodiments, a companion flow carries data used to coordinate joint reception operations by multiple access nodes. Joint reception operations involve capturing uplink data transmitted by UEs in a cooperative manner. Accordingly, in some embodiments the companion flows carry log-likelihood ratios (LLRs) to be shared between access nodes and used for interpreting received signals. In some embodiments, the companion flows carry quantized representations of received uplink signals from one access node to another. In some embodiments, the companion flows carry decoded and/or encoded data extracted from an uplink signal at one access point, for use by another access point in performing Successive Interference Cancellation (SIC). For SIC, a first access node may receive a first representation of a signal transmitted by a UE, and provide the first representation to a second access node. The second access node may then subtract the first representation from its received signal in order to cancel out signal interference caused by the UE at the second access node.

In some embodiments, a companion flow carries data used for CoMP operations, for example to facilitate coordinated transmission of data to UEs in the downlink. Companion flows may carry multicast data traffic and/or shared precoder or scheduling information, for example.

In some embodiments, a companion flow carries scheduling information used in coordinating scheduling operations involving multiple access nodes and/or schedulers. The scheduling information may flow from a coordinating scheduler to the access nodes, or the scheduling information may flow between access nodes. The scheduling information may include, for example, uplink and/or downlink grant information, power mask information provided by controller functions, and information identifying interfaces between access nodes, such as X2 interfaces usable for handover or other coordination operations.

In some embodiments, a companion flow carries administration data, for example indicative of how access nodes are to process uplink data and/or transmit downlink data.

In some embodiments, a companion flow carries data between access nodes for use in executing a handover operation, as would be readily understood by a worker skilled in the art.

Embodiments of the present invention provide a mechanism for requesting or negotiating for backhaul resources, for use in supporting communication via companion flows. For example, the backhaul resources may include communication resources reserved for supporting communication via an X2 interface or similar interface. An access node, scheduler, or other entity transmits the request to a TE controller, which directs the allocation of backhaul network resources in order to balance multiple concurrent requests from different entities. The TE controller is configured to allocate resources in a manner which balances multiple competing requirements, such as multiple requests for resources supporting companion flows, as well as requirements to communicate UE uplink and/or downlink data through the backhaul network. The TE controller may thus trade off backhaul resource allocations to support given data rate and/or Quality of Service (QoS) requirements for competing data flows.

Embodiments of the present invention are configured to allocate backhaul network resources in a manner which provides for an adequately high overall system performance, for example as measured by an objective function. The system performance is impacted at least partially by the size and quality of the companion flows, for example as reflected in the data rates and/or latencies experienced by data communicated in accordance with the companion flows. In various embodiments, it can be expected that system performance generally increases as more resources are allocated to uplink data flows, downlink data flows, and companion flows. However, because backhaul resources are limited, it is not considered possible to increase resource allocations indefinitely for every flow. Consequently, the TE controller is configured to balance the resources allocated to different companion flows, as well as the resources allocated to different data flows which communicate uplink and/or downlink data. Due to the time-varying nature of: the wireless medium; user traffic consumption; and user mobility, the requirements for backhaul traffic can fluctuate significantly over time. This fluctuation can be both up and down. Resources which would go unused due to downward fluctuations can be redistributed, by ongoing operation of the TE controller, to other nodes which are experiencing upward fluctuations.

In some embodiments, some of the backhaul resources which would be usable for conveying an uplink or downlink data flow may instead be allocated to support one or more companion flows. Although the uplink or downlink data flow rate may diminish by a nominal amount, such an allocation may be made in circumstances where this is offset by a benefit derived from the companion flow. The utility function may express the expected benefit of allocating one or more amounts of resources for use by particular companion flows.

To support a balanced resource allocation, utility functions are communicated from entities requesting backhaul resources to a TE controller capable of directing the allocation of backhaul resources. The utility function quantitatively reflects the nominal benefit derived from allocating a specified amount of backhaul resources to a specified task, such as support of a particular companion flow. The utility function may specify a quantitative utility value as a function of an input variable x reflecting the amount of backhaul resources, of one or more specified backhaul links and/or nodes, which are allocated to the specified task. The utility function may be a function of both backhaul data rates and companion flow data rates. The backhaul rates correspond to the rates of data flows to and/or from a gateway such as a SGW/PGW. The companion flow rates may correspond to the rates of X2 data flows, or to data flows supported by another control interface protocol. The input variable can be a scalar or vector variable. The TE controller allocates resources based on the utility functions reported thereto. The resource allocations may be selected in order to maximize or substantially maximize an objective function which reflects multiple utility functions, subject to constraints.

In some embodiments, the utility function corresponds at least partially to a utility of uplink and/or downlink data flow rates, and is a function of access link variables and/or backhaul rate variables. For example, the utility function may depend upon the path loss, or spectral efficiency of particular UEs. Additionally or alternatively, the utility function may depend on the amount of data traffic being transmitted to or received from a particular UE. Additionally or alternatively, the utility function may correspond to policies negotiated for different traffic flows serving different UEs, as well as the current state and/or current location of various UEs.

An example of a utility function which is a function of access links is:

$$U ( {r}_{BH} ) = {max}_{r} Σ {U}_{user} ( {r}_{i} )$$

$$s . t . Σ {r}_{i} \leq {r}_{BH} ;$$

$$Σ \frac{{r}_{i}}{{SE}_{i}} \leq 1.$$

Here, SEᵢ represents the spectral efficiency of user i, and Uᵤₛₑᵣ( ) is a measure of utility for each user. Common expressions of Uᵤₛₑᵣ( ) utilities are the PF metric (Uᵤₛₑᵣ(r)=log(r)). Other mappings are possible, using more accurate models of the access link or of users traffic. This utility function can be regarded as a function of the access link variable SEᵢ, because the function changes with respect to that variable.

Here and elsewhere, a utility function may be expressed in terms of a constrained optimization calculation. The independent variables of the utility function appear as parameters in the optimization calculation, and the result of the optimization calculation for a given value of the parameters is the corresponding value of the utility function.

In various embodiments, the utility function need not be explicitly expressed in terms of these access link variables. Instead the utility function may be represented by a piecewise curve fitting to the solutions to above constrained optimization problem. These curve fittings may be functions of only the variables associated with the traffic engineering controller (r_{BH} in the above), or of parameters and/or access link variables. Simple representations may be linear, spline representations, or other univariate or multivariate representations of the utility. Representations may be in the linear domain, or in another domain, for example expressed in dB in a logarithmic domain, for increased accuracy.

In some embodiments, the utility function corresponds at least partially to a utility of companion data flow rates, and is a function of access link variables and/or backhaul rate variables. For example, in regimes where the spectral efficiency increases when more data is available for companion flows, more data can be successfully received as companion flows increase. This can be represented in terms of increased utility. Consider a scenario where there are only two options for reception: either locally without using the companion flow; or jointly using a quantized signal from another node. The quantized signal requires X bits per unit of resource used. The utility can thus be expressed as:

$$U ( {r}_{BH} , {r}_{CF} ) = {max}_{r , s} Σ {U}_{user} ( {r}_{i} )$$

$$s . t . Σ {r}_{i} \leq {r}_{BH}$$

$$Σ \frac{{r}_{i}}{{SE}_{i}} \leq s$$

$$Σ \frac{{r}_{i}}{{SE}_{i}^{′}} \leq 1 - s$$

$$Xs \leq {r}_{CF}$$

Here, SEᵢ′ represents the spectral efficiency when the signal from the other antennas is available. Note that the above representations of the channel are relatively simplistic and significant improvements can be made at the expense of modeling the access link more accurately. Note however that inaccuracy in the access link model often does not necessarily have significant effect on the utility function.

In some embodiments, the utility function represents a real effect, such as an expected data rate, a monetary value transferred, or the like. In some embodiments, the utility function represents a nominal value, such as a quality of service or quality of experience value, a performance score, or the like. The utility function may be designed in various ways to reflect the desirability of various resource allocations or data rates supporting same.

In some embodiments, communicating a utility function can include communicating data to be interpreted as a utility function. The data indicative of the utility function may include sets of schedule actions, along with corresponding utility gains, amount of backhaul resources consumed, and/or amount of companion flow consumed. The data indicative of the utility function may include differential changes of utility about current or specified operating points. The data indicative of the utility function may include rate regions expressed as functions of companion flow rates. The data indicative of the utility function may include parameters or an explicit or implicit, partial or full expression of the utility function. The utility function may be a mathematical function, a lookup table, a set of conditional if-then statements, a set of computational instructions for calculating the utility, or the like.

In some embodiments, a TE controller or other control entity may be configured to receive indications of utility functions corresponding to currently active data flows, and recalculate resource allocations in response to changes to the utility functions. In some embodiments, the utility functions may depend on various other parameters, and the TE controller or other control entity itself may receive updates to wireless communication parameters and update corresponding utility functions. Upon changes to utility functions and/or constraints, the resource allocation solution can be recalculated and the resource allocation can be updated.

As such, rather than requesting allocation of a specified amount of resources, a network node or control function may indicate the utility function to a responsible TE controller, wherein the utility function implies the benefit or drawback associated with allocating resources in one or more associated manners. The TE controller then determines a resource allocation which results in an adequately high total utility, for example through an optimization calculation. The total utility incorporates the utility function indicated by the network node or control function, potentially along with the utility functions indicated by other entities. An entity such as an access node may therefore request backhaul resources by defining and communicating its utility function to a TE controller.

In one embodiment, the utility function indicates a single utility value associated with a given value xₐ of the input variable x. This utility value is deemed to be achieved if the amount of allocated backhaul resources is equal to at least xₐ. If the amount of allocated backhaul resources is less than xₐ, a default utility value, such as a zero value, is assumed.

In another embodiment, the utility function indicates multiple utility values, each associated with a different value of the input variable x. Such a utility function can be specified via parameters of a mathematical function or set of mathematical functions, a lookup table, or other means. For example, the utility function can be approximately represented by a polynomial of order n having the form:

U_{y}(x)=Aₙxⁿ+Aₙ₋₁xⁿ⁻¹+ . . . +A₁x+A₀.

The parameters of such a utility function can be communicated as a set of numerical values (A₀ . . . Aₙ). As another example, a lookup table is communicated by specifying a set of utilities and corresponding values of the input variable. The utility corresponding to unspecified values of the input variable is inferred using interpolation, for example. The utility function may be a discrete or continuous function of a discrete or continuous variable.

In various embodiments, each utility function communicated to the TE controller represents a contribution to an overall system utility. For example, a utility function may represent the data rate achievable in communicating with a particular UE or group of UEs. Alternatively the utility function may represent a Quality of Service (QoS), Quality of Experience (QoE) for a particular UE or group of UEs, or other relevant parameter which varies with the resource allocation.

The overall system utility can be represented as an aggregate of multiple utility functions communicated to the TE controller. For example, the overall system utility can be a sum of the multiple utility functions, or a minimum value of the multiple utility functions.

Conventionally, if a TE controller entity desires to globally solve an objective it performs something similar to the following optimization problem. Note that there are many different ways this problem can be represented, and the following is merely an example. We define the per-flow utility as U_{y}(ƒ(y)), where y is a label associated with the particular flow, and ƒ(y) is the element in a vector ƒ which represents the total data rate for that flow. Where r is a vector specifying the traffic flow for a particular user over a particular path, the data flow rate ƒ can be associated with r through the equation:

f=Hr,

where H is a matrix specifying the relation between paths and flows, in this case matrix entry H(i,j) is 1 if path i carries data for flow j, and is zero otherwise. As such, resource allocations for multiple paths through the backhaul support of a given user contribute to the flow rate allocated for that user. The vector r is typically constrained, for example by the pair of constraints:

rεR_{network}(r_{CF});

Cr≦c.

Here, R_{network}(r_{CF}) represents the wireless capacity of the network. This capacity is affected by the amount of companion flow traffic in the backhaul network. This set is unknown in general, however coarse approximations to it can be made, such as those expressed above for example using a form of Spectral Efficiency (SE) estimation. The matrix C represents the mapping of paths to backhaul links. Essentially C_{i,j}=1 if rate rᵢ uses resources on link j and is otherwise zero.

The overall optimization problem is thus:

$${max}_{r , {r}_{CF}} {Σ}_{y} {U}_{y} ( {f}_{y} ) \\ s . t . \text{:} r ∈ {R}_{network} ( {r}_{CF} ) ; \\ f = Hr ; \\ C [ \begin{matrix}{r}_{BH} \\ {r}_{CF}\end{matrix} ] \leq c . \qquad ( OPT 1 )$$

This requires the TE controller entity to have a working knowledge of R_{network}(r_{CF}), which is both difficult to express and dependent on the implementation and details of the wireless link.

In embodiments of the present invention, the aspects of the wireless link are hidden and instead the TE controller entity attempts to maximize the following:

$${Max}_{{r}_{BH} , {r}_{CF}} Σ U ( {r}_{BH} , {r}_{CF} ) \\ s . t . A [ \begin{matrix}{r}_{BH} \\ {r}_{CF}\end{matrix} ] \leq b \qquad ( OPT 1 a )$$

for single path optimization, or:

$${max}_{r} U ( {r}_{BH} , {r}_{CF} ) \\ s . t . [ \begin{matrix}{r}_{BH} \\ {r}_{CF}\end{matrix} ] = Hx \\ Ax \leq c , \qquad ( OPT 1 b )$$

for multipath optimization. The definition of H here is similar to the definition already described above in that H maps path rates (x) to flow rates

$$[ \begin{matrix}{r}_{BH} \\ {r}_{CF}\end{matrix} ] .$$

Arc-based formulations are also possible, as well as extensions to multicast flows (although heuristics must be used). Note that the matrix A is used here instead of C, reflecting that the path variables may correspond to different paths in this environment.

The above utility function U(r_{BH},r_{CF}) is a function not only of the uplink and/or downlink data rates but also of the companion flow data rates. To represent that U(r_{BH}, r_{CF}) is a function of the uplink and/or downlink data rates, where r_{BH} represents the vector of flows between nodes of the RAN via the backhaul network, the utility will generally be a non-decreasing function of components of r_{BH} which represents the rate of data flowing between a source node (or nodes) and a destination node (or nodes). To represent that U(r_{BH}, r_{CF}) is a function of the companion flow data rates, the utility will generally be a non-decreasing function of one or more other components of r_{CF} which represent rates allocated to companion flows between nodes which assist in communication with UE y.

In some embodiments there are multiple such utility functions representing either different portions of a wireless network or different flows altogether, corresponding to different business units. These different utilities can be combined together into a single system utility function. The system utility function incorporates the individual utility functions, for example U(r_{BH}, r_{CF})=Σ_{y}U_{y}(r_{BH},r_{CF}), or alternatively U(r)=Σ_{y}a_{y}U_{y}(r_{BH}, r_{CF}), where a_{y} are weighting functions, or U(r)=min_{y}U_{y}(r_{BH}, r_{CF}), or the like, or a combination thereof.

In some embodiments, the utility function is partially expressed in terms of constraints. These constraints are provided to the traffic engineering controller entity along with the utility function.

In various embodiments, a function U^{MAX} is defined to be a function of constraints, such as r_{BH}, and which maps a given set of constraints to a corresponding utility value given by a version of the above optimization problems. Similarly, the function r^{MAX} is defined, which maps a given set of constraints to the corresponding value of r which maximizes the above optimization problem. Further, the function ƒ^{MAX}=Hr^{MAX} may be defined.

Accordingly, a map of U^{MAX} as a function of a parameter such as r_{BH} can be defined. This allows the achievable system utility to be considered as a function of parameters of the backhaul network.

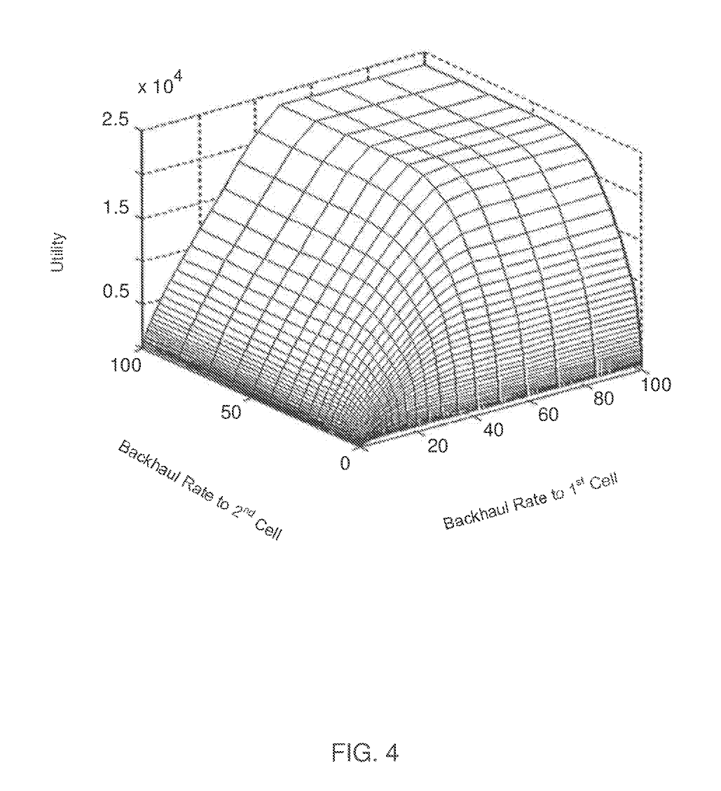

FIG. 4 illustrates an example graph showing an example utility function of two variables, such as the backhaul rate of a first cell and the backhaul rate of a second cell, for axes x, and y respectively. This utility function highlights the possible dependent nature of the two variables, for example in that the utility depends on both variables in combination.

In various embodiments, at least one of the individual utility functions U_{y}(r_{BH}, r_{CF}), and hence the system utility function U(r_{BH},r_{CF}), varies with one or more companion flow rates.

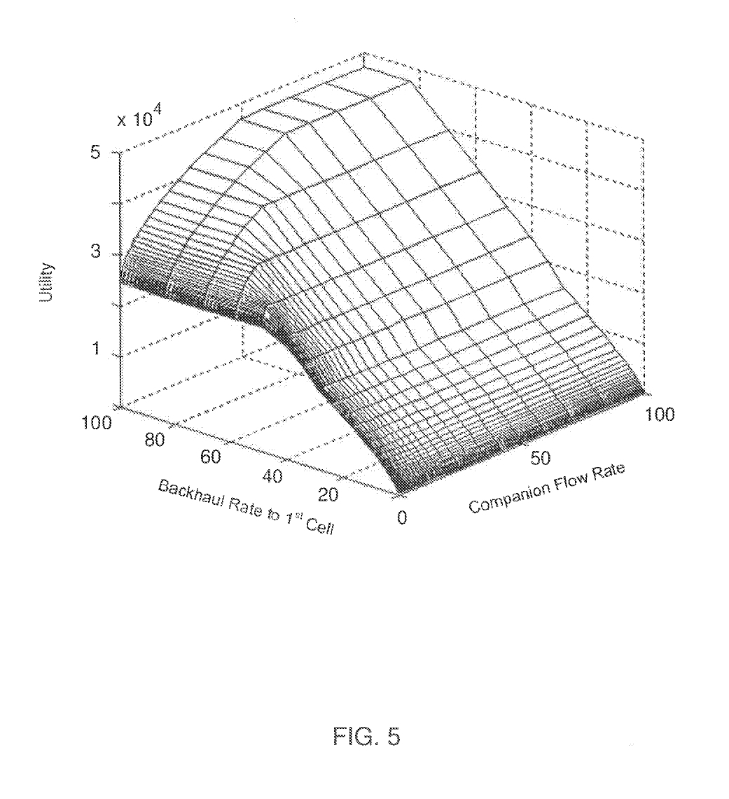

For example, FIG. 5 illustrates an example graph showing the utility function U(r_{BH}, r_{CF}) of a single cell with a single companion flow as a function of the companion flow rate and backhaul rate. This figure shows how the utility function can be non-linear and dependent upon multiple variables.

In various embodiments, the complexity of the optimization, from the perspective of the TE controller, is substantially independent of the number of users in the network. This situation is comparable to a standard network embedding problem. Further, the TE controller may already be balancing other comparable utility functions, and hence solving the optimization by the TE controller may be computationally and technologically feasible.

In various embodiments, as indicated above, the utility function above is based at least in part on wireless channel conditions. As such, the utility function changes dynamically in response to changing channel conditions, and re-optimization may be required on a correspondingly frequent basis. The utility function may further be based on factors such as user satisfaction with data services, for example.

In various embodiments the traffic engineering entity may periodically receive updates of the utilities that are actually experienced after having assigned resources. These updates may be used to adapt the received utilities via implementation of a feedback loop. If the experienced utility is lower than it should be the utility used in future resource assignments may be reduced. Conversely if it is higher than expected then the utility used may be increased. This is analogous to outer loop link adaptation (OLLA) but applied to utility functions. This scaling can be applied to the utility for all variables, for example by adapting utility functions according to:

U(x)=U(x)+Δ.

In some embodiments, the scaling may be applied over one or more different portions of the communication channel band.

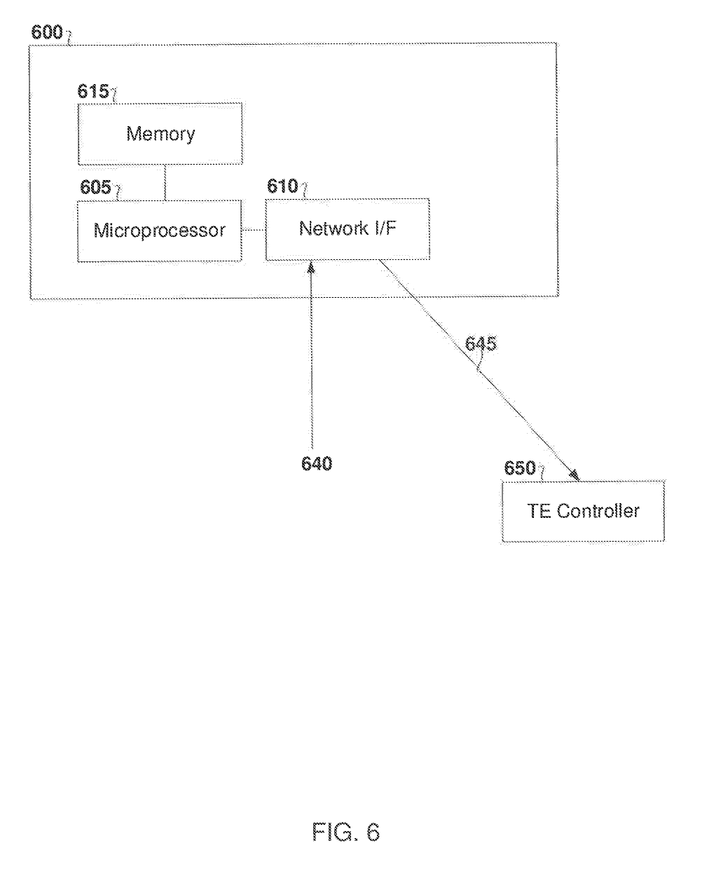

Having reference to FIG. 6, embodiments of the present invention provide for a network node or network controller device, such as a scheduler or access node comprising a scheduler, such as an eNB, associated with a wireless communication network. The device 600 includes a microprocessor 605, a network interface 610 and a memory 615 holding at least program instructions for execution by the microprocessor. The device may optionally be provided using Network Function Virtualization or similar techniques. The device is configured to identify, using the microprocessor and based at least partially on information 640 received via the network interface, one or more requirements for backhaul resources to be allocated for supporting flows of data between two or more network nodes. The device is further configured to generate, using the microprocessor, an indication of a utility function which expresses an amount of utility, also referred to as a utility metric, associated with at least one prospective backhaul resource allocation. Alternatively, the indication of the utility function may be generated by another entity. The device is further configured to communicate, using the network interface, the indication 645 of the utility function to a traffic engineering (TE) controller 650.

The above-described operation of the device may be performed by one or more functional modules, which include at least the microprocessor, network interface and memory operating in concert in a particular manner. For example, a utility function generation module may be provided which receives and/or identifies the backhaul resource requirements and determines the corresponding utility function. The device may also perform other operations, such as conventional scheduling and wired and/or wireless communication operations.

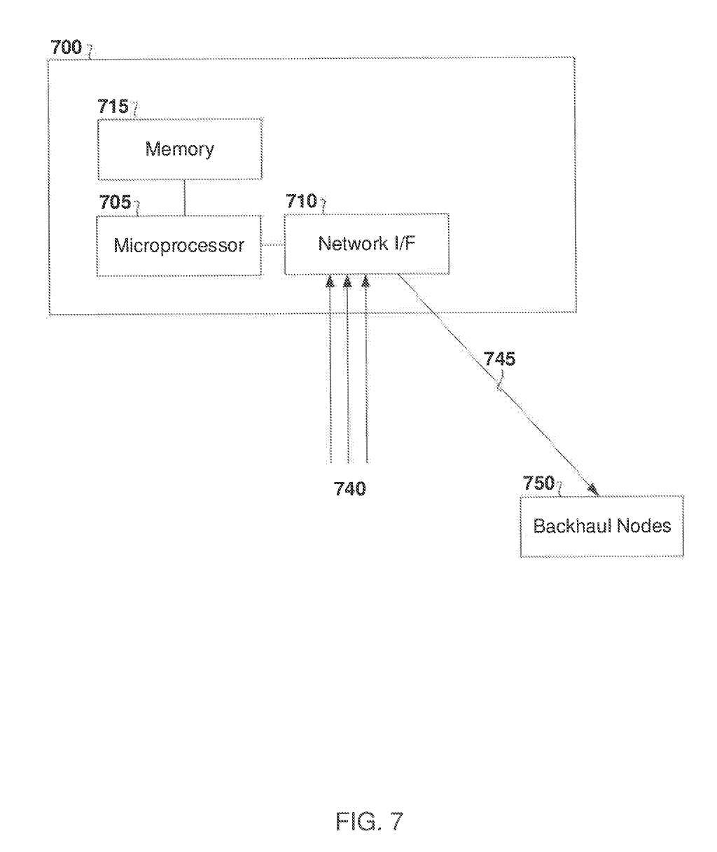

Having reference to FIG. 7, embodiments of the present invention provide for a TE controller associated with a wireless communication network, the TE controller 700 includes a microprocessor 705, a network interface 710 and a memory 715 holding at least program instructions for execution by the microprocessor. The TE controller may optionally be provided as described herein using Network Function Virtualization or similar techniques. The TE controller is configured to receive, using the network interface, one or more indications 740 of utility functions from network nodes and/or network controller devices of the RAN. The TE controller is further configured to generate, using the microprocessor, an objective function based at least partially on the indicated utility functions. The TE controller is further configured to obtain, via the network interface, and/or using the microprocessor, a set of constraints on backhaul resource allocations. Obtaining constraints may include receiving pre-specified constraints from other devices in the backhaul network. Obtaining constraints may include locally computing the constraints based on received information, for example from other devices in the backhaul network. The TE controller is further configured to generate, using the microprocessor, a resultant backhaul resource allocation which satisfies the set of constraints. The TE controller is further configured to communicate, via the network interface, the resultant backhaul resource allocation 745 to various backhaul nodes 750 for implementation.

The above-described operation of the TE controller may be performed by one or more functional modules, which include at least the microprocessor, network interface and memory operating in concert in a particular manner. For example, an optimization module may be provided which determines the objective function based on the indicated utility functions and/or other relevant information, determines the set of constraints, and determines the resultant backhaul resource allocation. The TE controller may also perform other operations, such as control of backhaul infrastructure devices.

In some embodiments, the TE controller may operate in conjunction with other TE controllers to solve, or partially solve the optimization problem in a distributed manner.

In some embodiments the TE controller may generate a network slice and/or provide an indication of a network slice to be used in response to receipt of the desired utility function. A network slice is represented by a series of logical links, nodes and capacities. The individual flows may then be transmitted over these logical links and presumably multiple flows may share the same constraints. For example, the amount of data carried by a first flow plus the amount of data carried by a second flow may be constrained to be less than or equal to the capacity of a given virtual link. This network slice may or may not be indicated to the requesting entity, and may or may not be explicitly indicated to the physical network. In some embodiments, provisioning for flows in the backhaul network involves instantiating one or more network slices for supporting one of more of the flows.

Various methods as disclosed herein may be implemented on one or more real or virtual computing devices, such as devices within a communication network control plane, devices operating in the data plane, or a combination thereof. Computing devices used to implement operations as described herein may include a processor operatively coupled to memory, the memory providing instructions for execution by the processor to perform the method as described herein.

Various embodiments of the present invention utilize real and/or virtual computer resources. Such computer resources utilize, at a hardware level, a set of one or more microprocessors operatively coupled to a corresponding set of memory components which include stored program instructions for execution by the microprocessors. Computing resources may be used to provide virtual computing resources at one or more levels of virtualization. For example, one or more given generic computer hardware platforms may be used to provide one or more virtual computing machines. Computer hardware, such as processor resources, memory, and the like, may also be virtualized in order to provide resources from which further virtual computing machines are built. A set of computing resources which are allocatable for providing various computing resources which in turn are used to realize various computing components of a system, may be regarded as providing a distributed computing system, the internal architecture of which may be configured in various ways.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A method of resource allocation in a backhaul network forming part of a radio access network, for execution by a network node, comprising:
identifying a requirement for backhaul resources to be allocated for supporting flows of data between network nodes in the backhaul network; and
transmitting an indication of a utility function, expressing a utility metric associated with a prospective backhaul resource allocation, to a traffic engineering (TE) controller.

2. The method of claim 1, wherein the utility function varies based on one or both of: rates of uplink or downlink data flow between one or more access nodes and one or more gateways; and data rates of companion flows between two or more access nodes, wherein companion flows carry data between network nodes for enhancing wireless communication performance above a baseline level.

3. The method of claim 1, wherein the utility function varies based on wireless channel conditions.

4. The method of claim 1, wherein the utility function varies based on predicted user traffic consumption.

5. The method of claim 2, wherein a companion flow comprises signals which have been received at a first node and transmitted to a second node, said signals used to facilitate a joint wireless signal reception operation.

6. The method of claim 2, wherein a companion flow comprises information indicative of future actions a wireless node is expected to perform.

7. The method of claim 1, wherein the utility function varies based on an amount of processing power allocated at a virtual node supporting the backhaul resource allocation.

8. The method of claim 1, wherein the utility function varies based on a Quality of Service (QoS) of at least one of said flows of data or of one or more companion flows associated with said flows of data.

9. The method of claim 8, wherein the QoS is indicative of at least one of packet delay and jitter.

10. The method of claim 1, further comprising receiving a response from the TE controller indicative of resources which have been allocated for supporting the flows of data, and using the resources which have been allocated for supporting the flows of data.

11. The method of claim 1, wherein the indication of the utility function comprises one of: an explicit indication of the utility function; a set of parameters indicative of the utility function; a lookup table indicative of the utility function; a set of schedulable actions along with associated utility values; an indication of a differential change in utility about an operating point; and a rate region expressed as a function of one or more data flow rates.

12. A method of resource allocation in a backhaul network forming part of a radio access network, for execution by a traffic engineering (TE) controller device, comprising:
receiving indications of utility functions from network nodes and/or network controller devices of the RAN;
generating an objective function based at least partially on the indicated utility functions;
obtaining a set of constraints on backhaul resource allocations;
generating a resultant backhaul resource allocation which satisfies the set of constraints; and
directing an allocation of resources according to the resultant backhaul resource allocation.

13. The method of claim 12, further comprising obtaining information indicative of one or more of: wireless channel conditions, conditions of infrastructure devices, and conditions of communication links in the backhaul network, wherein one or both of the objective function and the set of constraints is based at least partially on the obtained information.

14. The method of claim 12, wherein the utility functions are functions of two or more variables, and wherein different ones of the two or more variables are indicative of data rates of different flows in the backhaul network.

15. The method of claim 12, further comprising receiving one or more indications of access link variables, and wherein the allocation of resources includes an allocation of resources for supporting one or more companion flows.

16. The method of claim 12, wherein directing the allocation of resources comprises directing instantiation of one or more network slices for supporting the resultant backhaul resource allocation.

17. An apparatus for resource allocation in a backhaul network forming part of a radio access network, comprising: a microprocessor operatively coupled to memory and a network interface and configured to:
identify, using the microprocessor and based at least partially on information received via the network interface, a requirement for backhaul resources to be allocated for supporting flows of data between network nodes; and
transmit, using the network interface, an indication of a utility function, expressing a utility metric associated with a prospective backhaul resource allocation, to a traffic engineering (TE) controller.

18. The apparatus of claim 17, wherein the utility function varies based on one or more of: rates of uplink or downlink data flow between one or more access nodes and one or more gateways; wireless channel conditions; predicted user traffic consumption; an amount of processing power allocated at a virtual node supporting the backhaul resource allocation; a Quality of Service (QoS) of at least one of said flows of data or of one or more companion flows associated with said flows of data; and data rates of companion flows between two or more access nodes, and wherein companion flows carry data between network nodes for enhancing wireless communication performance above a baseline level.

19. The apparatus of claim 17, wherein the utility function varies based on data rates of companion flows between two or more access nodes, wherein a companion flow comprises signals which have been received at a first node and transmitted to a second node, said signals used to facilitate a joint wireless signal reception operation.

20. The apparatus of claim 17, further configured to receive a response from the TE controller indicative of resources which have been allocated for supporting the flows of data, and using the resources which have been allocated for supporting the flows of data.

21. An apparatus for resource allocation in a backhaul network forming part of a radio access network, comprising: a microprocessor operatively coupled to memory and a network interface and configured to:
receive, using the network interface, indications of utility functions from network nodes and/or network controller devices of the RAN;
generate, using the microprocessor, an objective function based at least partially on the indicated utility functions;
obtain, using one or both of the network interface and the microprocessor, a set of constraints on backhaul resource allocations;
generate, using the microprocessor, a resultant backhaul resource allocation which satisfies the set of constraints; and
direct, using the network interface, an allocation of resources according to the resultant backhaul resource allocation.

22. The apparatus of claim 21, further configured to obtain information indicative of one or more of: wireless channel conditions, conditions of infrastructure devices, and conditions of communication links in the backhaul network, wherein one or both of the objective function and the set of constraints is based at least partially on the obtained information.

23. The apparatus of claim 21, wherein the utility functions are functions of two or more variables, and wherein different ones of the two or more variables are indicative of data rates of different flows in the backhaul network.

24. The apparatus of claim 21, further configured to receive one or more indications of access link variables, and wherein the allocation of resources includes an allocation of resources for supporting one or more companion flows.

25. The apparatus of claim 21, wherein directing the allocation of resources comprises directing instantiation of one or more network slices for supporting the resultant backhaul resource allocation.
